(19) United States
(12) Patent Application Publication
(10) Pub. No.: US 2012/0192259 A1
(43) Pub. Date: Jul. 26, 2012

(54) METHOD, DEVICE AND SYSTEM FOR INFORMATION DOWNLOAD PROCESSING AND INFORMATION DOWNLOAD INDICATION

(75) Inventor: AIGUO YIN, Zhuhai (CN)

(73) Assignee: ZHUHAI SEINE TECHNOLOGY CO., LTD., ZHUHAI (CN)

(21) Appl. No.: 13/436,560

(22) Filed: Mar. 30, 2012

Related U.S. Application Data
(63) Continuation of application No. PCT/CN2010/079244, filed on Nov. 29, 2010.

(30) Foreign Application Priority Data
Dec. 21, 2009 (CN) 200910261905.3

(51) Int. Cl. H04L 9/32; G06F 21/00

(52) U.S. Cl. 726/7

(57) ABSTRACT

The present invention provides a method, device and system for information download processing and information download indication. In the present invention, because an imaging device has been registered with paid web sites successfully when leaving the factory, a user can access the paid web sites only by installing drivers. According to a protocol, the user can access the paid web sites and acquire data by means of the imaging device, and correspondingly, manufacturer of the imaging device pays a fee to the paid web sites. Thereby, after purchasing the imaging device, the user can access the paid web sites to acquire the free data as long as the imaging device is connected to a computer capable of being connected with the Internet and the driver of the imaging device is installed on the computer. The present invention eliminates need for the user to register and pay to obtain paid data.

### CROSS-REFERENCE TO RELATED APPLICATIONS

This application is a continuation of International Application No. PCT/CN2010/079244 filed on Nov. 29, 2010, which claims the priority benefit of Chinese Patent Application No. 200910261905.3, filed on Dec. 21, 2009. The contents of the above identified applications are incorporated herein by reference in their entirety.

### FIELD OF THE TECHNOLOGY

The present invention relates to an information download technology, in particular to method, device and system for information download processing and information download indication.

### BACKGROUND

With rapid development of Internet technology, a user can access the Internet through a computer to acquire needed network resources such as pictures, characters and the like. A user accesses the network resources by using a computer and prints the needed data through a printer connected with the computer for use. Most network resources are distributed on various network provider servers, and a user accesses the provider servers through a computer, downloads the needed data from the provider servers and prints the data through a printer.

However, not all resources provided by provider servers are free, namely a user has to pay for certain pictures and character data. If a user needs to download the paid data from certain provider server, he/she needs permission of the provider server. Generally, if a user needs to acquire the paid data, he/she needs to register a member account on a web site for providing the paid data, and then recharges the member account so as to purchase the needed data from the web site. Specifically, before downloading and printing the needed data, a user accesses the paid web site through a computer, fills in the member account and the password, sends an authentication request including the member account and the password to the provider server corresponding to the web site through the computer, and after the member account passes the authentication, the provider server permits the computer to download the paid data.

Therefore, the above method for obtaining the paid data causes some inconveniences, for example, the member account must be registered and then the account is recharged; if more data are needed, the account needs to be recharged for many times; and if less data are needed, the account password and the like may be forgotten due to low use frequency, so that the operation of the user is complex, and the service quality of resource sharing is low.

### SUMMARY

The present invention provides a method, device and system for information download processing and information download indication, which overcomes the defects of low service quality and the like caused by the need for a user to input the member account in advance when the paid data are downloaded, thus enabling the user to obtain the paid data from the web sites conveniently, securely and freely.

One aspect of the present invention provides a method for information download processing, comprising:

sending, by a computer, an authentication request message to a provider server corresponding to a web site to be accessed by a user, wherein the authentication request message at least comprises a device identifier which is acquired from an imaging device connected with the computer and used for uniquely identifying the imaging device; and

receiving, by the computer, a success response message sent back from the provider server which performs an authentication to the imaging device according to stored registration information, then receiving data information requested to be printed by the user and forwarding the data information to the imaging device,

wherein the registration information comprises the device identifiers corresponding to imaging devices which are successfully registered with the provider server.

The method for information download processing further comprises:

receiving, by the provider server corresponding to the web site, the authentication request message sent by the computer; and

performing, by the provider server, the authentication to the imaging device according to the stored registration information, returning the success response message, and then sending the data information requested to be printed by the user to the computer to indicate the computer to forward the data information to the imaging device.

The method for information download processing further comprises:

sending, by the imaging device, the device identifier for uniquely identifying the imaging device to the computer connected with the imaging device, so that the computer sends the authentication request message to the provider server corresponding to the web site to be accessed by the user for requesting the provider server to perform the authentication to the imaging device according to the stored registration information; and

receiving, by the imaging device, the data information, which is forwarded by the computer and requested to be printed by the user, after the provider server performs the authentication to the imaging device successfully.

Another aspect of the present invention provides an imaging device, comprising:

a seventh processing module, configured to send a device identifier for uniquely identifying the imaging device to a computer connected with the imaging device, so that the computer sends an authentication request message to a provider server corresponding to a web site to be accessed by a user for requesting the provider server to perform authentication to the imaging device according to stored registration information, wherein the registration information comprises device identifiers corresponding to the imaging devices which are successfully registered with the provider server; and

an eighth processing module, configured to receive data information forwarded by the computer and requested to be printed by the user after the provider server successfully authenticates the imaging device.

Another aspect of the present invention provides a system for information download processing, comprising a computer device and a provider server device operably connected with each other through the Internet, and an imaging device operably connected with the computer device,

wherein the computer device sends an authentication request message to the provider server device corresponding to a web site to be accessed by a user, the authentication request message at least comprising a device identifier which is acquired from the imaging device and used for uniquely identifying the imaging device; the provider server device performs authentication to the imaging device according to stored registration information and sends a success response message to the computer device, the registration information comprising device identifiers corresponding to the imaging devices which are successfully registered with the provider server device; the provider server device sends data information requested to be printed by the user to the computer device, and the computer device receives the data information and then forwards the data information to the imaging device; and the imaging device receives the data information.

According to the method, device and system for information download processing and information download indication provided by the present invention, a user can search the needed data by means of the imaging device through the authentication of the paid web site and print the needed data through the imaging device, so that the user can conveniently, securely and freely acquire the paid data from the paid web site, thus the operation is simple and convenient, and the service quality is improved.

### BRIEF DESCRIPTION OF THE DRAWINGS

In order to describe the embodiments of the present invention or the technical solution in the prior art more clearly, drawings needed for describing the embodiments or the prior art will be introduced in brief hereinafter. Obviously, what are described in the following drawings are only some embodiments of the present invention and the ordinary skill in the art can obtain other embodiments according to the drawings without any creative work and without departure from the scope and spirit of the present invention.

FIG. 1 is a flow chart of a method for information download processing according to embodiment I of the present invention;

FIG. 2 is a flow chart of a method for information download indication according to an embodiment of the present invention;

FIG. 3 is a flow chart of a method for information download processing according to embodiment II of the present invention;

FIG. 4 is a flow chart of a method for information download processing according to embodiment III of the present invention;

FIG. 5 is a structural schematic view of a computer device according to an embodiment of the present invention;

FIG. 6 is a structural schematic view of a provider server device according to an embodiment of the present invention;

FIG. 7 is a structural schematic view of an imaging device according to an embodiment of the present invention;

FIG. 8 is a structural schematic view of a system for information download processing according to embodiment I of the present invention; and

FIG. 9 is a structural schematic view of a system for information download processing according to embodiment II of the present invention.

### DETAILED DESCRIPTION

In order to make the purposes, technical solution and advantages of the embodiments of the present invention clearer, the technical solution according to embodiments of the present invention will be clearly and completely described hereinafter referring to the drawings. Obviously, those described here are not all but only a part of embodiments of the present invention. On the basis of the described embodiments of the present invention, other embodiments and modifications obtained by a person of the ordinary skill in the art without any creative work are also within the protection scope of the present invention.

As network resources are continuously enriched, a user can download the needed data through networks. However, in the prior art, the provider server for providing the data generally requires the user to register a member account and recharge the member account, and then the user can purchase the needed paid data from web site. Defects such as complex operation of the user and low service quality of resource sharing may be caused due to inconvenience during the user acquires the paid data according the prior art.

Aiming at the defects of the prior art, embodiments of the present invention provide a solution, namely, the imaging device such as a printer for printing paid data information in the network may register a member account on a provider server corresponding to a paid web site in advance, so that the authentication of the printer by the provider server is completed before a computer connected with the printer accesses the paid web site and requests to download the paid data information. The whole authentication process can be actively executed by hardware without the participation of the user. A user can directly access the paid web site and download the needed paid data information through a printer. The solutions according to embodiments of the present invention enable a user to conveniently, securely and freely acquire the paid data from a paid web site.

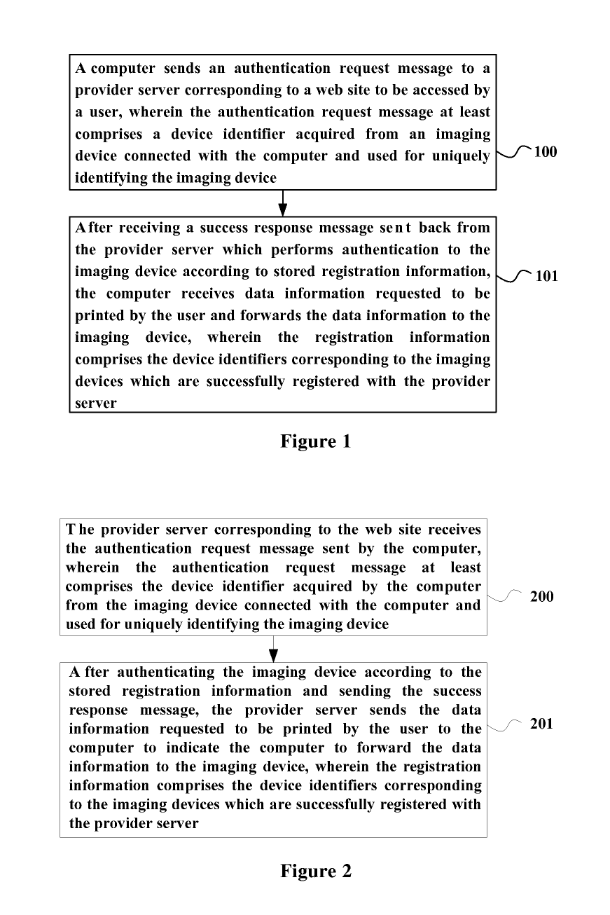

FIG. 1 is a flow chart of a method for information download processing according to embodiment I of the present invention. As shown in FIG. 1, the method comprises:

Step 100, a computer sends an authentication request message to a provider server corresponding to a web site to be accessed by a user, wherein the authentication request message at least comprises a device identifier acquired from an imaging device connected with the computer and used for uniquely identifying the imaging device; and

the user operates the computer to access the paid web site, and if the provided paid data information needs to be downloaded from the web site, the user can directly click a download and print function option provided by the web site. Then, the computer sends the authentication request message to the provider server corresponding to the web site to be accessed by the user to request the provider server to authenticate the identity of a printer connected with the computer. In the embodiment, the provider server performs the authentication to a hardware device, such as a printer, instead of the account registered by the user in the prior art. As long as the authentication of the printer is successful, the paid data information needed by the user can be sent to the computer.

The authentication request message sent to the provider server from the computer at least comprises a device identifier, and the device identifier can be configured to uniquely identify the imaging device, for example, the device identifier can be a global unique identifier or an electronic key (such as ikey or ukey) or the like. The computer may acquire the device identifier from the imaging device connected with the computer, specifically, after the printer is connected to the computer in a connecting mode such as USB and the like by the user, a driver of the imaging device is installed in the computer, so that the computer is in initialized connection with the imaging device. After the driver is successfully installed, the computer can acquire the device identifier from the imaging device.

Step 101, after receiving a success response message sent back from the provider server which performs authentication to the imaging device according to stored registration information, the computer receives data information requested to be printed by the user and forwards the data information to the imaging device, wherein the registration information comprises the device identifiers corresponding to the imaging devices which are successfully registered with the provider server.

After the computer sends the authentication request message to the provider server, the provider server receives the authentication request message and extracts the device identifier in the authentication request message to perform authentication. The authentication specifically comprises that the provider server searches the stored registration information which comprises the device identifiers corresponding to the respective imaging devices which are successfully registered with the provider server, namely after the user account for one printer is successfully registered with the provider server, the provider server adds a piece of record into the maintained registration information to store the device identifier corresponding to this printer. After the provider server receives the authentication request message, if the device identifier carried by the authentication request message is found in the registration information, the printer successfully passes the authentication. After the printer is successfully authenticated, the provider server sends a success response message to the computer. If the device identifier carried by the authentication request message cannot be found in the registration information, the authentication fails, and the authentication request is rejected. The identity authentication of the printer in the embodiment can be performed by adopting a port based network access control, such as IEEE8021.x, an electronic key (such as ikey or ukey) or other known process, and thus no more details will be given here again.

After receiving the success response message sent back from the provider server, the computer acknowledges that the imaging device connected with the computer has passed the authentication, and the paid data information can be downloaded from the provider server and printed through the imaging device. The user searches the needed paid data by operating the computer and browsing the homepage of the data; and after the needed paid data is found, the user downloads the data by clicking a relevant function option. After acquiring the instruction that the user requests for printing, the computer sends a printing request to the provider server, wherein the printing request comprises a link address corresponding to the information requested to be printed by the user, for example, an IP address and the like. The provider server acquires the needed data according to the link address and feeds the data back to the computer.

In the embodiment, the computer acquires the data information to be printed by the user in the following two modes, wherein a remote access printing technology is involved and introduced as follows.

In the first mode, the computer receives the data information directly sent by the provider server, and forwards the data information to the imaging device.

The data information is acquired by encapsulating the original information requested to be printed by the user in a preset format through the provider server, and the encapsulation of the preset format in each embodiment of the present invention comprises the steps of converting the original information into language information of the preset format and then encapsulating the data information expressed by the language information of the preset format. Under this condition, the computer is directly in communication with the provider server. Specifically, after the user raises a printing request, the computer sends the printing request to the provider server; after receiving the printing request, the provider server calls “Spooler” (simultaneous peripheral operations online) service thereof and simultaneously clears the printing jobs without response in time by using printing queue management; the data to be printed by the user are created into a file of the preset format by using a printer driver or a virtual printing driver of the provider server, wherein the preset format in each embodiment of the present invention can be a preset printing format such as EMF, XPS or the like; then the provider server transmits the printing file of the preset format to the computer; the computer calls the “Spooler” service thereof and caches the printing file of the preset format in a page; and finally, a printer driver of the computer drives the printer to print the file.

In the second mode, the computer receives the data information sent by a service server arranged between the provider server and the computer, and forwards the data information to the printer.

The data information is acquired by encapsulating the original information sent by the provider server and requested to be printed by the user in a preset format through the service server. Under this condition, the computer is in communication with the provider server by means of transfer of the service server. Specifically, after the user raises a printing request, the computer sends the printing request to the provider server; after receiving the printing request, the provider server acquires the original information requested to be printed by the user according to the link address and then sends the original information to the service server; then, the service server calls “Spooler” service thereof and simultaneously clears the printing jobs without response in time by using printing queue management; the data to be printed by the user are created into a file of the preset format (such as EMF, XPS or the like) by using a printer driver or a virtual printing driver of the provider server; the service server transmits the printing file of the preset format to the computer; the computer calls the “Spooler” service thereof and caches the printing file of the preset format in a page; and finally, a printer driver of a client (computer) drives the printer to print the file.

In the above two modes, no matter the computer directly receives the data information sent by the provider server or receives the data information sent by the service server, the received data information is expressed by a preset printing language, cached in a page by directly calling the “Spooler” service of the computer and then printed through the printer driver, thus the data information is not stored in the computer. The printer can identify the file described in the preset printing language and prints the file into characters or images. Therefore, in the method provided by the embodiment, the information downloaded from the provider server can only be printed by the registered printer and then be acquired by the user.

In addition, the printer may not carry out printing process, but store the downloaded data information, for example, in a memory thereof or in a plug-in memory of the printer. The user can also temporarily store the downloaded data information in a mobile storage medium. Certainly, in order to prevent the downloaded data information from being printed by other printer by the user, the stored data information can be encrypted, so that the data information cannot be decrypted by other printer, and the data information can only be printed by the registered printer. The encryption of the data information can be performed by the provider server, and under this condition, the provider server and the printer may appoint a password in advance; and certainly, the encryption can be dealt by the printer. The encryption algorithm can be a conventional encryption algorithm in the prior art, and is not limited here.

According to the method for information download processing provided by the present embodiment of the present invention, the imaging device has been registered with the paid web site when leaving the factory, thus the user can access the paid web site by installing the driver. According to a protocol, the user can access the paid web site and acquire the data by means of the imaging device, and correspondingly, the manufacturer of the imaging device can pay to the web site according to pages. Therefore, after the user purchases the imaging device, as long as the imaging device is connected with the computer which may be connected with the Internet and the driver of the imaging device is installed in the computer, the user can access the paid web site and freely acquire the data, so the problem that the user can acquire the needed paid data only by registration and payment is solved; and the user can conveniently, securely and freely acquire the paid data from the paid web site, the operation is simple and convenient, and the service quality is improved.

FIG. 2 is a flow chart of a method for information download indication according to an embodiment of the present invention. As shown FIG. 2, the method comprises:

Step 200, a provider server corresponding to a web site receives an authentication request message sent by a computer, wherein the authentication request message at least comprises a device identifier acquired by the computer from an imaging device connected with the computer and used for uniquely identifying the imaging device; and

a user operates the computer to access the paid web site, and if provided paid data information needs to be downloaded from the web site, the user can directly click the download and print function option provided by the web site. Then, the computer sends the authentication request message to the provider server corresponding to the web site to be accessed by the user to request the provider server to authenticate the identity of a printer connected with the computer. The authentication request message sent to the provider server from the computer at least comprises a device identifier, and the device identifier can be configured to uniquely identify the imaging device, for example, the device identifier can be a global unique identifier or a U key or the like. The computer may acquire the device identifier from the imaging device connected with the computer, specifically, after the printer is connected to the computer in a connecting mode such as USB and the like by the user, a driver of the imaging device is installed in the computer; and after the driver is installed successfully, the computer can acquire the device identifier from the imaging device. The provider server receives the authentication request message sent by the computer.

Step 210, after authenticating the imaging device according to a stored registration information and sending a success response message, the provider server sends data information requested to be printed by the user to the computer to indicate the computer to forward the data information to the imaging device, wherein the registration information comprises the device identifiers corresponding to the imaging devices which are successfully registered with the provider server.

After receiving the authentication request message, the provider server extracts the device identifier in the authentication request message to perform authentication to the printer. The authentication specifically comprises that the provider server searches the stored registration information which comprises the device identifiers corresponding to the respective imaging devices which are successfully registered with the provider server, namely after the user account for one printer is successfully registered with the provider server, the provider server adds a piece of record into the maintained registration information to store the device identifier corresponding to the printer. After the provider server receives the authentication request message, if the device identifier carried by the authentication request message is found in the registration information, the printer successfully passes the authentication. After the printer is successfully authenticated, the provider server sends a success response message to the computer. If the device identifier carried by the authentication request message cannot be found in the registration information, the authentication fails, and the authentication request is rejected. In the embodiment, the provider server determines whether or not to permit the computer to download the paid data according to the authentication result of the printer connected with the computer; and as long as the printer is previously registered with the provider server, the authentication can succeed. Certainly, the provider server also binds the download traffic to the device identifier of the printer, and subsequently the corresponding expense resulting from the download can be acquired from the provider of the printer according to the protocol.

After receiving the success response message sent back from the provider server, the computer acknowledges that the printer connected with the computer has passed the authentication, and the paid data information can be downloaded from the provider server and printed through the printer. The user searches the needed paid data by browsing the homepage of the data with the computer; and after the needed paid data is found, the user downloads the data by clicking the function option. After acquiring the instruction that the user requests for printing, the computer sends a printing request to the provider server, wherein the printing request comprises a link address corresponding to the information requested to be printed by the user, for example, an IP address and the like.

The provider server acquires the needed data according to the link address and feeds the data back to the computer. The feedback mode of the information can comprise that: after the provider server acquires the original information according to the link address, the original information is converted into a file of a preset format through a printer driver of the provider server, the file is directly sent to the computer page by page through the Internet and cached page by page by calling the “Spooler” service of the computer, and the printer driver directly drives the printer to print the cached file of the special format. Certainly, the original information can be sent to a service server positioned between the computer and the provider server, the original information is converted into the file of the preset format through the printer driver of the service server, the file is sent to the computer by using a page as a unit, the file is cached page by page by calling the “Spooler” service of the computer, and the printer driver directly drives the printer to print the cached file of the special format.

After receiving the data information, the computer directly forwards the data information to the printer. After receiving the data information of the preset format, the printer prints the data information into characters or images for reading of the user. Because the data information is cached by calling the “Spooler” and then directly sent to the printer to print, the data information is not stored in the computer. Or, the printer stores the data information, and afterwards the printer prints the data information.

According to the method for information download indication provided by the embodiment of the present invention, the provider server can send the paid data to a computer connected with an imaging device based on the hardware authentication of the imaging device and indicate the computer to directly print the paid data through the printer. The user does not need to frequently input the user account and the password and the like through the computer to realize download of the paid data, so that the problem that the user can only acquire the needed data by registration and payment is solved, and the user can conveniently, securely and freely acquire the paid data from the paid web site; and the operation is simple and convenient, and the service quality is improved.

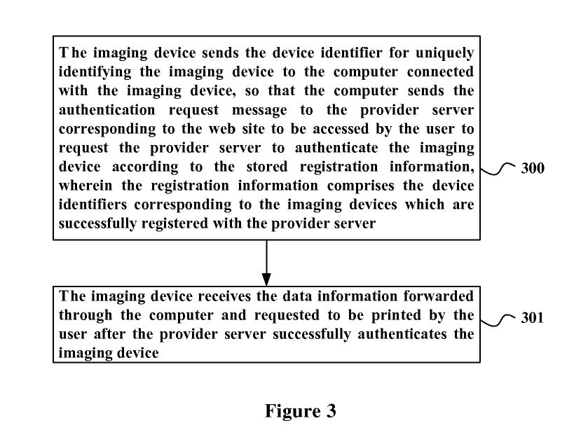

FIG. 3 is a flow chart of a method for information download processing according to embodiment II of the present invention. As shown in FIG. 3, the method comprises:

Step 300, an imaging device sends a device identifier for uniquely identifying the imaging device to a computer connected with the imaging device, so that the computer sends an authentication request message to a provider server corresponding to the web site to be accessed by a user to request the provider server to authenticate the imaging device according to stored registration information, wherein the registration information comprises the device identifiers corresponding to the imaging devices which are successfully registered with the provider server; and

Step 301, the imaging device receives data information forwarded through the computer and requested to be printed by the user after the provider server successfully authenticates the imaging device.

After a printer receives the data information, the data information can be directly printed according to the setting, or the data information is temporarily stored in a memory or a plug-in memory of the printer and then printed by the printer, and the details refer to the above-mentioned embodiments.

The present embodiment relates to the flows of the related imaging device in the flows of the above methods, and the introduction of the specific steps is detailed by the embodiments of the above methods and omitted here. In the present embodiment, the imaging device has been registered with the web site for providing the paid data information; if the registration succeeds, the related record can be found in the provider server corresponding to the web site. The authentication can be successfully passed with the registered device identifier of the imaging device subsequently sent by the computer, and the paid data information can be downloaded.

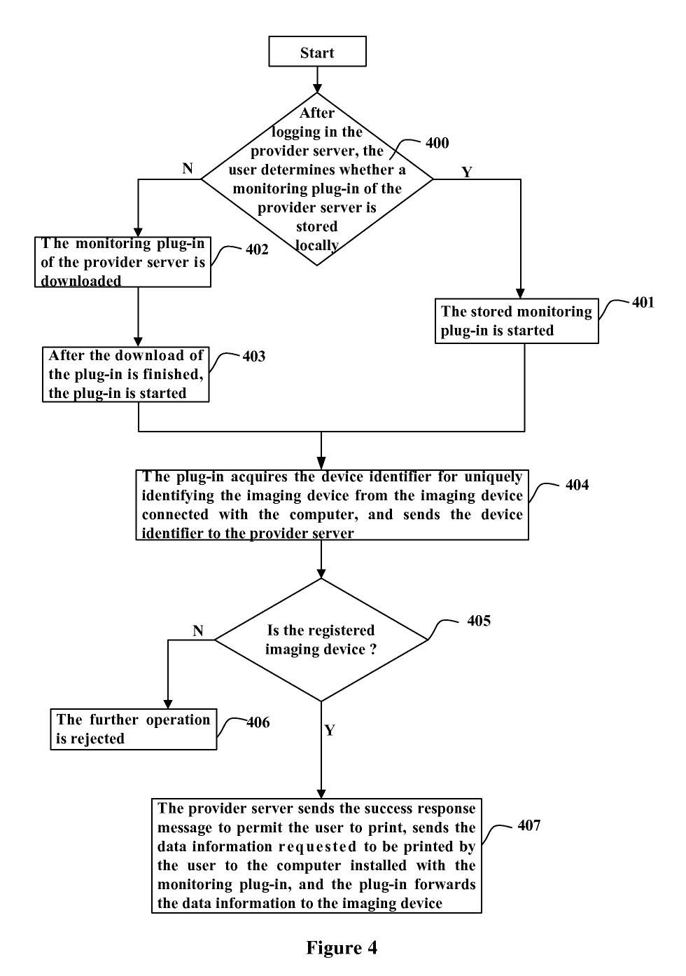

FIG. 4 is a flow chart of a method for information download processing according to embodiment III of the present invention. As shown in FIG. 4, the method comprises:

Step 400, after logging in a provider server, a user determines whether a monitoring plug-in of the provider server is stored locally, if so, the step 401 is executed, otherwise, the step 402 is executed;

Step 401, a client automatically starts the stored monitoring plug-in;

Step 402, the client downloads the monitoring plug-in of the provider server;

Step 403, after the client downloads the monitoring plug-in, the monitoring plug-in is started, and the step 404 is executed;

Step 404, the plug-in acquires a device identifier for uniquely identifying an imaging device from the imaging device connected with a computer, and sends the device identifier to the provider server to authenticate the imaging device;

Step 405, the provider server authenticates the imaging device according to stored registration information, if it is successful, the step 407 is executed, otherwise, the step 406 is executed;

Step 406, the further operation of the user is rejected, and the request of the user for printing the data from the web site is rejected; and

Step 407, the provider server sends a success response message to permit the user to print, sends the data information requested to be printed by the user to the computer installed with the monitoring plug-in after the user requests for printing, and the plug-in forwards the data information to the imaging device for printing.

When the provider server in embodiments of the present invention responds to the request of the user and sends the data needed to be printed, the data can be encrypted by the conventional encryption algorithm such as DES (Data Encryption Standard), 3DES (Triple DES), AES (Advanced Encryption Standard), RSA, Elgamal and the like, and no more details will be given here again.

According to the method for information download processing provided by the present embodiment of the present invention, the imaging device have registered with the paid web site when leaving the factory, the user can access the paid web site by installing a driver. According to a protocol, the user can access the paid web site and acquire the data by means of the imaging device, and correspondingly, the manufacturer of the imaging device can pay to the web site according to pages. Therefore, after the user purchases the imaging device, as long as the imaging device is connected with the computer which may be connected with the Internet and the driver of the imaging device is installed in the computer, the user can access the paid web site and freely acquire the data, so that the user can conveniently, securely and freely acquire the paid data from the paid web site, the operation is simple and convenient, and the service quality is improved.

FIG. 5 is a structural schematic view of a computer device according to an embodiment of the present invention. As shown in FIG. 5, the computer device comprises a first processing module 11 and a second processing module 12, wherein:

the first processing module 11 is configured to send an authentication request message to a provider server corresponding to a web site to be accessed by a user, wherein the authentication request message at least comprises a device identifier acquired from an imaging device connected with the computer and used for uniquely identifying the imaging device; and

the second processing module 12 is configured to receive a success response message sent back from the provider server which performs an authentication to the imaging device according to stored registration information, then receive data information requested to be printed by the user and forward the data information to the imaging device, wherein the registration information comprises device identifiers corresponding to the imaging devices which are successfully registered in the provider server.

Specifically, the computer device can be connected with the Internet and is connected with the imaging device such as a printer. The user operates the computer to access the paid web site, and the first processing module 11 in the computer sends the authentication request message to the provider server corresponding to the web site to be accessed by the user so as to request the provider server to authenticate the identity of the printer connected with the computer. The provider server can carry out hardware authentication to the printer according to the device identifier which is carried by the authentication request message and used for uniquely identifying the printer. If the authentication is successful, the success response message is send to the computer; and after receiving the success response message send from the provider server, the computer acknowledges that the printer connected with the computer has passed the authentication, and it can download the paid data information from the provider server and print the paid data information through the printer.

The computer acquires the instruction that the user requests for printing and sends a printing request to the provider server, wherein the printing request comprises a link address corresponding to the information requested to be printed by the user. The provider server sends the needed data information according to the link address, and the second processing module 12 receives the data information and forwards the data information to the printer for printing. According to different data information sending modes of the provider server, the second processing module 12 can receive the data information converted to a preset format through a driver of the provider server, or can receive the data information which is sent to the service server by the provider server and converted to a preset format through a driver of the service server. In the present embodiment, the computer device may comprise a fourth processing module 14 configured to acquire the instruction that the user requests for printing and send the printing request to the provider server.

In the present embodiment, the computer device may comprise a third processing module 13 configured to acquire the device identifier for uniquely identifying the printer from the printer and store the device identifier after the computer is in initialized connection with the printer. The authentication request message is sent to the provider server through the first processing module 11.

The specific functions of the computer device provided by the present embodiment can refer to the embodiments of the above-mentioned methods and no more details will be given here again.

According to the computer device provided by the present embodiment of the present invention, after the user purchases the registered imaging device, as long as the imaging device is connected to the computer and the driver of the imaging device is installed, the user can access the paid web site and freely acquire the data, so the problem that the user can acquire the needed paid data only by registration and payment is solved; and the user can conveniently, securely and freely acquire the paid data from the paid web site, the operation is simple and convenient, and the service quality is improved.

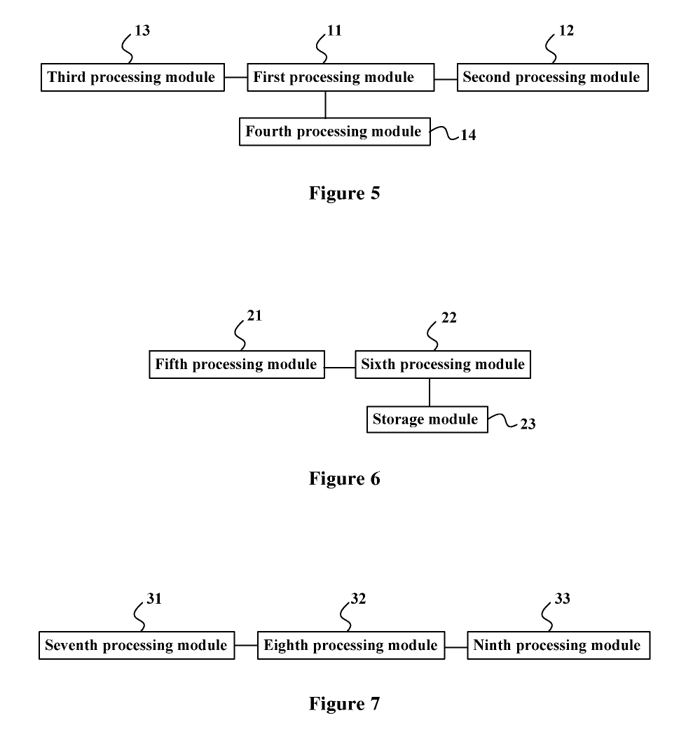

FIG. 6 is a structural schematic view of a provider server device according to an embodiment of the present invention. As shown in FIG. 6, the provider server device comprises a fifth processing module 21 and a sixth processing module 22, wherein:

the fifth processing module 21 is configured to receive the authentication request message sent by the computer, wherein the authentication request message at least comprises the device identifier which is acquired by the computer from the imaging device connected with the computer and used for uniquely identifying the imaging device; and

the sixth processing module 22 is configured to authenticate the imaging device according to the stored registration information, send the success response message, and then send the data information requested to be printed by the user to the computer to indicate the computer to forward the data information to the imaging device, wherein the registration information comprises device identifiers corresponding to the imaging devices which are successfully registered with the provider server.

Specifically, after the fifth processing module 21 in the provider server receives the authentication request message which is sent by the computer and carries the device identifier of the printer, the sixth processing module 22 searches the device identifier in the registration information, and if the device identifier is found, the success response message is sent. After the link address of the data to be downloaded by the user sent from the computer is received, the provider server sends the data information to the computer through the sixth processing module 22, and the data in the data information are in a preset format and only used for the printer. After the original information is found according to the link address, the sixth processing module 22 can convert the original information to the preset format, encapsulate the original information and return the encapsulated original information to the computer.

In the present embodiment, the registration information used when the sixth processing module 22 authenticates the printer can be maintained through a storage module 23, and the storage module 23 is configured to store the device identifiers corresponding to the imaging devices which are successfully registered with the provider server.

The specific functions of the provider server device provided by the present embodiment can refer to the embodiments of the above-mentioned methods and no more details will be given here again.

According to the provider server device provided by the present embodiment of the present invention, the provider server device can send the paid data to the computer connected with the imaging device based on the hardware authentication of the imaging device so as to indicate the computer to directly print the paid data through the printer, and the user does not need to frequently input the user account and the password and the like through the computer to realize download of the paid data, so that the problem that the user can only acquire the needed data by registration and payment is solved, and the user can conveniently, securely and freely acquire the paid data from the paid web site. Thus, the operation is simple and convenient, and the service quality is improved.

FIG. 7 is a structural schematic view of an imaging device according to an embodiment of the present invention. As shown in FIG. 7, the imaging device comprises a seventh processing module 31 and an eighth processing module 32, wherein the seventh processing module 31 is configured to send the device identifier for uniquely identifying the imaging device to the computer connected with the imaging device, so that the computer sends the authentication request message to the provider server corresponding to the web site to be accessed by the user for requesting the provider server to perform authentication to the imaging device according to the stored registration information, wherein the registration information comprises the device identifiers corresponding to the imaging devices which are successfully registered with the provider server; and the eighth processing module 32 is configured to receive data information forwarded by the computer and requested to be printed by the user after the provider server successfully authenticates the imaging device.

The imaging device provided by the present embodiment can comprise a ninth processing module 33 configured to store the data information in a memory or a plug-in memory of the imaging device, or directly print the data information.

The specific functions of the imaging device provided by the present embodiment can refer to the embodiments of the above-mentioned methods and no more details will be given here again.

According to the imaging device provided by the present embodiment of the present invention, the problem that the user can only acquire the needed data by registration and payment is solved, and the user can conveniently, securely and freely acquire the paid data from the paid web site. Thus, the operation is simple and convenient, and the service quality is improved.

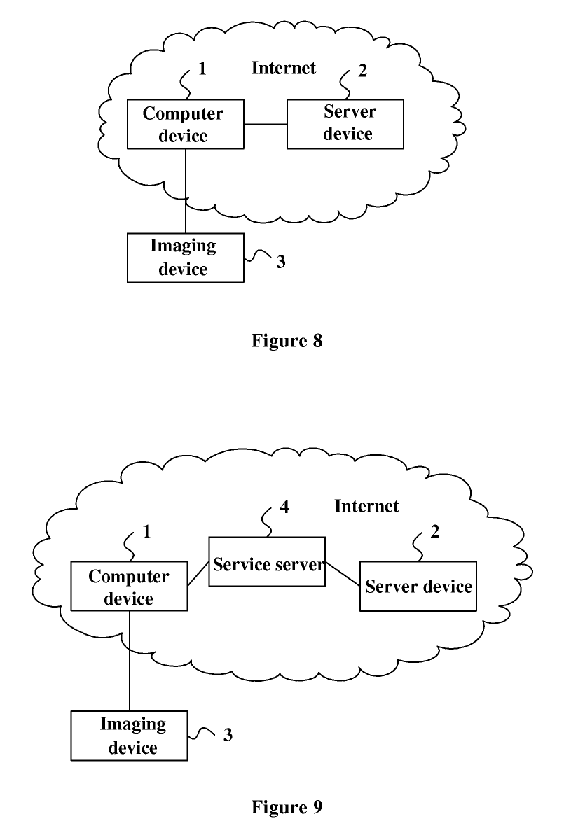

FIG. 8 is a structural schematic view of an information download processing system according to embodiment I of the present invention. As shown in FIG. 8, the system comprises a computer device 1 and a provider server device 2 operably connected with each other through the Internet, and an imaging device 3 operably connected with the computer device 1, wherein:

the computer device 1 sends the authentication request message to the provider server device 2 corresponding to a web site to be accessed by a user, wherein the authentication request message at least comprises the device identifier which is acquired from imaging device 3 and used for uniquely identifying the imaging device 3; the provider server device 2 performs the authentication to the imaging device 3 according to the stored registration information and returns the success response message to the computer device 1, wherein the registration information comprises the device identifier corresponding to the imaging device 3 which is successfully registered with the provider server device 2; the provider server device 2 sends, to the computer device 1, data information requested to be printed by the user and encapsulated in the preset format; the computer device 1 receives the data information and then forwards the data information to the imaging device 3; and the imaging device 3 receives the data information.

In addition, the imaging device 3 in the present embodiment is also configured to store the received data information in a memory or a plug-in memory of the imaging device 3, or directly print the data information.

The specific functions and the structures of the computer device, the provider server device and the imaging device provided by the present embodiment can refer to the embodiments of the above-mentioned devices and no more details will be given here again.

FIG. 9 is a structural schematic view of a system for information download processing according to embodiment II of the present invention. As shown in FIG. 9, the system comprises computer device 1 and provider server device 2 operably connected with each other through the Internet, a service server 4 positioned between the computer device 1 and the provider server device 2, and imaging device 3 operably connected with the computer device 1, wherein:

the computer device 1 sends the authentication request message to the provider server device 2 corresponding to a web site to be accessed by a user, wherein the authentication request message at least comprises the device identifier which is acquired from imaging device and used for uniquely identifying the imaging device; the provider server device 2 authenticates the imaging device according to the stored registration information and returns the success response message to the computer device 1, wherein the registration information comprises the device identifier corresponding to the imaging device 3 successfully registered with the provider server device 2; the provider server device 2 sends original information requested to be printed by the user to the service server 4; the service server 4 encapsulates the original information in a preset format to obtain data information, and forwards the data information to the computer device 1; the computer device 1 receives the data information and then forwards the data information to the imaging device 3; and the imaging device 3 receives the data information and then stores or prints the data information.

The specific functions and the structures of the computer device, the provider server device and the imaging device provided by the present embodiment can refer to the embodiments of the above-mentioned devices and no more details will be given here again.

According to the system for information download processing provided by each embodiment of the present invention, the problem that the user can only acquire the needed data by registration and payment is solved, and the user can conveniently, securely and freely acquire the paid data from the paid web site. Thus, the operation is simple and convenient, and the service quality is improved.

The methods and the devices according to the above embodiments are only explained under the condition that the user acquires the paid data of the paid web site freely. Certainly, the application of each embodiment of the present invention is not limited here, and the embodiments can be applied to other conditions likewise, for example, a web site can provide free data, but it divides the users into different levels due to the factors such as traffic or the number of the users and the like. For example, the users are divided into common users and VIP users according to the on-line time, download traffic and the like, and only the VIP users are allowed to download the data in specific time period. By using the technical solutions provided by the present invention, the users can enjoy VIP treatment without the limitation of time period and traffic, and download the needed data without any obstruction. Therefore, the embodiments of the present invention can meet various requirements of the users and improve the service quality.

Those of ordinary skill in the art may understand that, all or a portion of the steps in the above method examples may be implemented by instructing relevant hardware via a program. The program may be stored in a computer-readable storage medium. Once the program is executed, the steps of the above method examples are accordingly performed. The above storage medium includes any medium capable of storing program codes such as a ROM, a RAM, a magnetic disk, or an optical disk.

Finally, it should be noted that the above examples are merely provided for describing the technical solutions of the present invention, but not intended to limit the present invention. It should be understood by the ordinary skill in the art that although the present invention is described in detail with reference to the foregoing embodiments, modifications can be made to the technical solutions described in the foregoing embodiments, or equivalent replacements can be made to some technical features in the technical solutions, without the essence of corresponding technical solutions departing from the scope of the embodiments of the present invention.

What is claimed is:

1. A method for information download processing, comprising:
sending, by a computer, an authentication request message to a provider server corresponding to a web site to be accessed by a user, wherein the authentication request message at least comprises a device identifier which is acquired from an imaging device connected with the computer and used for uniquely identifying the imaging device; and
receiving, by the computer, a success response message sent back from the provider server which performs an authentication to the imaging device according to stored registration information, then receiving data information requested to be printed by the user and forwarding the data information to the imaging device,
wherein the registration information comprises the device identifiers corresponding to imaging devices which are successfully registered with the provider server.

2. The method according to claim 1, wherein the step of receiving data information requested to be printed by the user and forwarding the data information to the imaging device further comprises:
receiving the data information which is requested to be printed by the user and encapsulated in a preset format and forwarding the data information to the imaging device.

3. The method according to claim 2, wherein the step of receiving the data information which is requested to be printed by the user and encapsulated in the preset format and forwarding the data information to the imaging device further comprises:
receiving the data information directly sent by the provider server, and forwarding the data information to the imaging device, wherein the data information is obtained by encapsulating original information, which is requested to be printed by the user, in the preset format through the provider server; or
receiving the data information sent by a service server arranged between the provider server and the computer, and forwarding the data information to the imaging device, wherein the data information is obtained by encapsulating original information, which is sent by the provider server and requested to be printed by the user, in the preset format through the service server.

4. The method according to claim 1, before sending, by the computer, the authentication request message to the provider server corresponding to the web site to be accessed by the user, the method further comprises:
enabling an initialized connection between the computer and the imaging device, and acquiring, by the computer, the device identifier for uniquely identifying the imaging device from the imaging device.

5. The method according to claim 2, before sending, by the computer, the authentication request message to the provider server corresponding to the web site to be accessed by the user, the method further comprises:
enabling an initialized connection between the computer and the imaging device, and acquiring, by the computer, the device identifier for uniquely identifying the imaging device from the imaging device.

6. The method according to claim 3, before sending, by the computer, the authentication request message to the provider server corresponding to the web site to be accessed by the user, the method further comprises:
enabling an initialized connection between the computer and the imaging device, and acquiring, by the computer, the device identifier for uniquely identifying the imaging device from the imaging device.

7. The method according to claim 1, wherein the step of forwarding the data information to the imaging device comprises:
forwarding the data information to the imaging device by using a page as a unit.

8. The method according to claim 2, wherein the step of forwarding the data information to the imaging device comprises:
forwarding the data information to the imaging device by using a page as a unit.

9. The method according to claim 3, wherein the step of forwarding the data information to the imaging device comprises:
forwarding the data information to the imaging device by using a page as a unit.

10. The method according to claim 1, before receiving the data information requested to be printed by the user and forwarding the data information to the imaging device, the method further comprises:
after the computer acquires an instruction that the user requests for printing, the computer sends a printing request to the provider server, wherein the printing request comprises a link address corresponding to the information requested to be printed by the user.

11. The method according to claim 2, before receiving the data information requested to be printed by the user and forwarding the data information to the imaging device, the method further comprises:
after the computer acquires an instruction that the user requests for printing, the computer sends a printing request to the provider server, wherein the printing request comprises a link address corresponding to the information requested to be printed by the user.

12. The method according to claim 3, before receiving the data information requested to be printed by the user and forwarding the data information to the imaging device, the method further comprises:
after the computer acquires an instruction that the user requests for printing, the computer sends a printing request to the provider server, wherein the printing request comprises a link address corresponding to the information requested to be printed by the user.

13. The method according to claim 1, further comprising:
receiving, by the provider server corresponding to the web site, the authentication request message sent by the computer; and
performing, by the provider server, the authentication to the imaging device according to the stored registration information, returning the success response message, and then sending the data information requested to be printed by the user to the computer to indicate the computer to forward the data information to the imaging device.

14. The method according to claim 13, before sending the data information requested to be printed by the user to the computer, the method further comprises:
receiving, by the provider server, a printing request sent by the computer, wherein the printing request comprises a link address corresponding to the information requested to be printed by the user; and
acquiring, by the provider server, original information according to the link address, and encapsulating the original information in a preset format to obtain the data information.

15. The method according to claim 13, wherein the step of sending the data information requested to be printed by the user to the computer comprises:
sending the data information requested to be printed by the user to the computer by using a page as a unit.

16. The method according to claim 14, wherein the step of sending the data information requested to be printed by the user to the computer comprises:
sending the data information requested to be printed by the user to the computer by using a page as a unit.

17. The method according to claim 1, further comprising:
sending, by the imaging device, the device identifier for uniquely identifying the imaging device to the computer connected with the imaging device, so that the computer sends the authentication request message to the provider server corresponding to the web site to be accessed by the user for requesting the provider server to perform the authentication to the imaging device according to the stored registration information; and
receiving, by the imaging device, the data information, which is forwarded by the computer and requested to be printed by the user, after the provider server performs the authentication to the imaging device successfully.

18. The method according to claim 17, after receiving, by the imaging device, the data information, the method further comprises:
the imaging device stores the data information in a memory or a plug-in memory of the imaging device; or
the imaging device directly prints the data information.

19. An imaging device, comprising:
a seventh processing module, configured to send a device identifier for uniquely identifying the imaging device to a computer connected with the imaging device, so that the computer sends an authentication request message to a provider server corresponding to a web site to be accessed by a user for requesting the provider server to perform authentication to the imaging device according to stored registration information, wherein the registration information comprises device identifiers corresponding to the imaging devices which are successfully registered with the provider server; and
an eighth processing module, configured to receive data information forwarded by the computer and requested to be printed by the user after the provider server successfully authenticates the imaging device.

20. The imaging device according to claim 19, further comprising:
a ninth processing module, configured to store the data information in a memory or a plug-in memory of the imaging device, or directly print the data information.

21. A system for information download processing, comprising a computer device and a provider server device operably connected with each other through the Internet, and an imaging device operably connected with the computer device,
wherein the computer device sends an authentication request message to the provider server device corresponding to a web site to be accessed by a user, the authentication request message at least comprising a device identifier which is acquired from imaging device and used for uniquely identifying the imaging device; the provider server device performs authentication to the imaging device according to stored registration information and sends a success response message to the computer device, the registration information comprising device identifiers corresponding to the imaging devices which are successfully registered with the provider server device; the provider server device sends data information requested to be printed by the user to the computer device, and the computer device receives the data information and then forwards the data information to the imaging device; and the imaging device receives the data information.

22. The system according to claim 21, wherein the imaging device is also configured to store the received data information in a memory or a plug-in memory of the imaging device, or directly print the data information.
